(19) United States
(12) Patent Application Publication
(10) Pub. No.: US 2024/0025103 A1
(43) Pub. Date: Jan. 25, 2024

(54) SWITCHING DEVICE AND METHOD FOR SWITCHING A FLAT FILM MACHINE FROM AN INPUT PRODUCT TO A SUBSEQUENT PRODUCT

(71) Applicant: Windmöller & Hölscher KG, Lengerich (DE)

(72) Inventors: Torsten SCHMITZ, Lengerich (DE); Waldemar COLELL, Lengerich (DE); Bernd-Alexander GROEPPER, Lengerich (DE)

(73) Assignee: Windmöller & Hölscher KG, Lengerich (DE)

(21) Appl. No.: 17/291,641

(22) PCT Filed: Nov. 5, 2019
(86) PCT No.: PCT/EP19/80261

§ 371 Date: May 6, 2021

(30) Foreign Application Priority Data
Nov. 6, 2018 (DE) 10 2018 127 679.6

(51) Int. Cl. B29C 48/92; B29C 48/08; B29C 48/305

(52) U.S. Cl. CPC B29C 48/92; B29C 48/08; B29C 48/305; B29C 2948/92133; B29C 2948/92209; B29C 2948/92152; B29C 2948/92904; B29C 2948/92066

(57) ABSTRACT

The invention relates to a changing device (10) for a changing of a flat film machine (100) from a feed product (EP) to a follow-on product (FP), comprising a sensor module (20) for acquiring at least one production parameter (PP) of the flat film machine (100) and an adjusting module (30) for a controlled change of this acquired at least one production parameter (PP), further comprising a controlling module (40) for controlling the adjusting module (30) for an optimized changing time (TU) for the acquired at least one production parameter (PP) from the feed product (EP) to the follow-on product (FP).

The present invention relates to a changing device for changing a flat film machine from a feed product to a follow-on product and to a method for optimized changing of a flat film machine from a feed product to a follow-on product.

It is well known to use flat film machines to produce film products. Such flat film machines usually comprise a combination of extrusion devices which produce a flowable material composition as a melt. A flat film melt can be discharged over an outlet width via a nozzle device with an outlet nozzle, and picked up and drawn off by a draw-off roll. After the film melt has cooled to form a film track, it can be further drawn off and wound onto a film roll. In addition, it is also possible to coat or laminate the melt. For example, one or more flat tracks can be added to the melt for this purpose.

A disadvantage of the known solutions is that the changing between different film products, i.e. from a currently produced feed product to a follow-on product to be produced subsequently, is relatively time-consuming. The high time requirement is based in particular on the fact that a plurality of the changings have to be carried out manually. The changing from a feed product to a follow-on product can be expressed in terms of a plurality of very different parameters. These can be, for example, the material composition, the layer thickness ratio, the geometric ratios, such as the width of the respective product, or similar parameters. Accordingly, in order to carry out the changing from the feed product to the follow-on product, one or more production parameters of the flat film machine usually have to be adapted or changed. Since this is at least partly done manually by the operating personnel of the flat film machine, the changing cannot be carried out here in a reproducible manner. Rather, the duration of the changing as well as the quality of the changing from the feed product to the follow-on product depends essentially exclusively on the experience of the operating personnel. The fact that several changing steps are frequently carried out in iterative fashion, in particular sequentially one after the other, leads not only to reduced reproducibility and the described dependence on the operating personnel, but also to a significantly increased changing time.

It is an object of the present invention to at least partially eliminate the disadvantages described above. In particular, it is an object of the present invention to provide an optimized changing time in a cost-effective and simple manner, which in particular enables the changing from a feed product to the follow-on product in a reproducible manner.

The preceding object is solved by a changing device with the features of claim 1 and a method with the features of claim 12. Further features and details of the invention result from the dependent claims, the description and the figures. Features and details which are described in connection with the changing device according to the invention naturally also apply in connection with the method according to the invention and vice versa in each case, so that reference is or can always be made mutually with regard to the disclosure concerning the individual aspects of the invention.

According to the invention, a changing device is used for a changing of a flat film machine from a feed product to a follow-on product. For this purpose, the changing device comprises a sensor module for acquiring at least one production parameter of the flat film machine. Furthermore, an adjusting module for a controlled change of this acquired at least one production parameter is provided. Furthermore, the changing device comprises a controlling module for controlling the adjusting module for an optimized changing time for the acquired at least one production parameter from the feed product to the follow-on product.

According to the invention, the changing device is therefore based on essentially three core components, namely the sensor module, the adjusting module and the controlling module. With the aid of the sensor module, it is now possible for the first time to directly acquire production parameters of the flat film machine. This direct acquisition of production parameters can extend directly or indirectly to corresponding product parameters of the film product, i.e. the feed product and/or the follow-on product. The sensor module is thus able to acquire the production parameters of the flat film machine not only during normal use in the production of the film product, but also for the transition between the feed product and the follow-on product. With this known information about the at least one production parameter, the changing method explained later can now be carried out. In order to be able to intervene in the changing from the feed product to the follow-on product in an at least partially automated or fully automated manner, the adjusting module is provided. The adjusting module correlates with the sensor module in such a way that the controlled change can be carried out by the adjusting module for at least this acquired at least one production parameter of the sensor module. If the sensor module is, for example, the possibility of acquiring the discharge width from the outlet nozzle as a production parameter, the adjusting module accordingly and specifically has a controlled change possibility for this discharge width. This can be, for example, an automated or partially automated method of lateral sealing blades, which can also be referred to as deckling blades. In other words, the sensor module can acquire the production parameters that can subsequently be changed in a controlled manner by the adjusting module.

In addition to a classical controlling possibility, i.e. the possibility of intervention of the adjusting module, a controlling module is additionally provided in the changing device according to the invention. This allows the controlling of the adjusting module not only in a basic regulation loop, but for an optimized changing time for the acquired at least one production parameter. In a first step, it is irrelevant for the functioning of the present invention whether the changing time has been optimized in the course of the changing method or already before, for example during commissioning or during the design of the flat film machine. An optimized changing time is in particular a reduced changing time, which is shorter than it would be achievable with a manual changing according to the prior art.

The controlling module is now able to adapt the adjusting module with regard to its controlled adjusting intervention in the at least one acquired production parameter in such a way that an improved, namely an optimized changing time can be achieved. This optimized changing time is focused in particular on the duration of the changing time. However, other key points, for example production stability, product quality, the amount of material required for changing, and other parameters can of course also have an influence on the optimization logic of the changing time. In addition to the preliminary optimization during commissioning or design of the flat film machine, the optimization can of course also be carried out at least partially within the flat film machine or within the changing device and there within the controlling module.

For the changing from a feed product to a follow-on product, for example, the following procedure can now be followed. In a simple changing, the material composition of the two film products remains essentially the same, but the desired net width, for example, changes from the feed product to the follow-on product. If this is the case, it can be assumed, for example, that after producing a narrow feed product, a wider follow-on product is now desired. To ensure this, the sensor module is able to acquire at least one production parameter which is related to the width of the film product. In particular, the outlet width of the outlet nozzle of the flat film machine must be taken into account. For the changing, the outlet width must now be moved or adjusted to a value for the outlet nozzle which allows the desired wider follow-on product to be produced. The sensor module is thus able to acquire the at least one production parameter in the form of the outlet width, while the adjusting module is able to change the outlet width in a controlled manner in such a changing device. The controlling module can now, when controlling the adjusting module, work towards optimizing the necessary changing time, which is thus required for widening the outlet width and thus for achieving the desired wider follow-on product. This can be achieved, for example, by appropriate automated adjustment of lateral deckling blades.

Due to the correlation of the sensor module, the specific adjusting module and the controlling module acting on the latter according to the invention, the regularly achievable optimized changing time can be significantly reduced compared to manual solutions. At the same time, it is possible to maintain or at least improve the stability of production during the changing, so that an undesired production stop due to a break in the film track can be essentially ruled out.

The generation of reject production during the changing time can also be improved due to the reduced changing time. Last but not least, a decisive advantage of a changing device according to the invention is that in this way a reproducible changing and thus also a reproducible quality from the feed product to the follow-on product can be achieved.

There may be advantages if, in a changing device according to the invention, at least one of the following is acquired as a production parameter by the sensor module:
width of the film track
number of layers of the film track
material composition of the film track
quality parameter of the film track
production stability of the film track
thickness of the film track
film thickness ratio of the film track
temperature profile of the film track
width difference of the film track
adjusting profile of adjusting bolts of the outlet nozzle
machine parameter of the flat film machine
discharge width of the outlet nozzle
thickness profile of the film track.

The above list is not exhaustive. The width of the film track can be understood to be the net width, but in particular the gross width before any edge sections of the film track are cut off. The number of layers may be variable or constant. The material composition of the film track refers in particular to different materials for the different layers. Thus, different plastic materials can be used for different layers in order to be able to provide different functionalities in the layer composition for the film track when viewed together. The quality parameters of the film track can also be related in part to the material composition. However, it is also conceivable that production parameters, such as the stretching ratio and the associated stretching of the film track, which will be explained later, have a decisive influence on the quality of the film track. A cooling speed of the film track, for example via a vacuum box, an air knife and/or a casting roller temperature are also conceivable as production parameters. It is also important for the production itself that the film track reaches a certain basic quality in order to prevent the film track from breaking, so that a minimum level of production stability can be achieved. The thickness of the film track can be adjusted by a wide variety of adjusting parameters. These include, for example, the stretching ratios, which will also be explained later, the draw-off speed, and also the speed of the melt feed. The layer thickness ratio of the film track within the individual layers, as well as the overall thickness of the film track, can also be used as production parameters. The temperature profile of the film track can be acquired, in particular transversely to the conveying direction. With regard to the cooling speed explained, it is also conceivable to acquire the temperature in the production direction, i.e. along the film track. Also, the width difference of the film track, which can be achieved for example by a neck-in in the edge section, but also by the distinction between gross width and net width, can be used as production parameter. Within the adjustment of the discharge thickness at the outlet nozzle, for example, adjusting bolts are used, whose adjusting profile can also serve as a production parameter. Other machine parameters, such as the use of a vacuum box, the location and/or thickness of an electrostatic pinning can also be used. The discharge width can also be used as an indirect determinant of the width of the film track. Last but not least, the thickness profile of the film track transverse to the conveying direction is also a possible production parameter in the sense of the present invention. As has already been explained, these production parameters, which can be acquired by the sensor module, apply as a basis for an adjusting module oriented to this adjustment of these production parameters as well as a controlling module correlated therewith.

Further advantages can be achieved if, in a changing device according to the invention, the adjusting module is configured for controlling at least one nozzle parameter of an outlet nozzle of the flat film machine. Such a nozzle parameter can be used, for example, as a production parameter in the form of the thickness profile, in the form of the width of the discharge slot and in the form of the thickness of the film track. For example, lateral sealing blades can automatically change the width as a nozzle parameter of the outlet nozzle. Adjustable adjusting bolts, for example so-called thermal bolts, can change the discharge thickness of the film track at the outlet nozzle. For example, a real discharge slot at the nozzle, which is established by the force equilibrium of said adjusting bolts and the corresponding counter-pressure of the melt discharging from the discharge slot, can serve as the basis for the changing device according to the invention. The stretching ratio of supplied melt and draw-off speed, which will be explained later, can also be used here.

Further advantages can be achieved if, in a changing device according to the invention, a nozzle discharge slot of the discharge nozzle as at least one nozzle parameter and thus the local thickness of the discharged film track can be changed locally in a controlled manner. Such a nozzle parameter in the form of a nozzle discharge slot makes it possible to directly influence the stabilization of the film track. In particular, a thickness profile can be monitored in the transverse direction so that, in addition to monitoring the stability of the melt, the edges and/or the film track, undesirable thick spots, so-called piston rings, can be avoided at local points. The monitoring of such a nozzle parameter is carried out in particular as local monitoring, which acts on one or more adjacent adjusting bolts. However, global or partially global controlling of the nozzle parameters is also conceivable in principle.

Further advantages can be achieved if, in a changing device according to the invention, the adjusting module is designed for a controlled variation of an outlet width of the outlet nozzle. Here again, lateral sealing blades, so-called deckling blades, can be moved in a controlled and, in particular, automatic manner. These can also be double or multi-part sealing blades which are retracted or extended into the outlet nozzle, particularly in a symmetrical manner on both sides, in order to vary the outlet width of the outlet nozzle.

It is also advantageous if, in a changing device according to the invention, the adjusting module is designed for a controlled variation of a stretching parameter of the flat film machine.

Depending on the feeding speed at which melt passes through the discharge nozzle as a melt throughput, the draw-off speed can be used to determine the stretching ratio of the film track in relation to this. The faster the draw-off speed is designed for the same melt throughput, the greater the stretching ratio of the film track. It should be noted that the draw-off speed can be changed relatively easily and, above all, quickly, while the melt throughput itself can be changed slowly and only to a limited extent. Thus, in particular, the stretching parameter is set by adjusting the regulation of the speed of the draw-off roll by the adjusting module.

It is also advantageous if, in a changing device according to the invention, the controlling module comprises an input device for inputting the follow-on product and/or a changing time. This input can, of course, also be designed automatically as an interface to the flat film machine. The input can also be provided at least partially by the operating personnel or by the commissioning or already by a factory setting. With regard to the changing time, in particular an upper limit is specified which must not be exceeded for the corresponding changing.

Furthermore, it brings advantages if, in a changing device according to the invention, the controlling module is configured for an input of an optimization focus, in particular one of the following:
threshold value for minimum production stability
threshold value for maximum changing time
threshold value for a maximum energy requirement
threshold value for minimum product quality.

The above list is not exhaustive. The input of an optimization focus can be provided as a factory default, as a commissioning default, but also by the operating personnel at the controlling module. In this way, a minimum production stability can be specified, so that even with a reduced changing time, the reduction is not achieved at the expense of falling below this minimum production stability. This ensures that a film track break can be avoided with maximum security. Also, the maximum changing time can be prioritized so that it is avoided that a maximum changing time, which is, for example, specified as the overall target for the changing on the flat film machine, is exceeded. The energy requirement can also be limited to a maximum, for example by limiting the maximum recycled edge width, i.e. the maximum width at the edge strip that has to be re-melted. The same applies to the product quality, which is also coupled, for example, with a corresponding recirculation rate of the cut-off edge strips of the film track. Of course, the individual threshold values can also be combined with each other and provided with different prioritizations. Thus, two or more parallel threshold values are also conceivable as input optimization focal points in the sense of the present invention.

It is also advantageous if an output device for an output of a predicted changing time is provided in a changing device according to the invention. It is therefore possible to inform the operating personnel of the flat film machine at the start of the changing from the feed product to the follow-on product as to when the follow-on product will run in good production. In this way, manual work, such as a roll change of a winding roll, can be carried out by the operator in the corresponding predicted changing time. In this case, the necessary manual work can also be displayed on the output device in the form of auxiliary steps, in particular also in the specified sequence for guiding the operator.

There are further advantages if, in a changing device according to the invention, the controlling module comprises a storage device for a specific storage of effected changings from feed products to follow-on products. Such a storage device thus serves as a database for reproducibility. In particular, successful changings are stored with all corresponding changing parameters or production parameters, so that future changings can be carried out on the basis of previous successful changings. Also, a successful changing can be interpolated or further processed in the storage device to draw conclusions about similar changing recipes. In this way, the storage device can be used to provide a learning changing system, so to speak, which continuously optimizes the changing time during operation, in particular across different flat film machines.

In a changing device according to the preceding paragraph, it is advantageous if the storage device comprises an evaluation module for a quantitative and/or qualitative evaluation of the stored changings. This allows the learning system to be further improved and new or further or higher-level optimizations to be made possible. Existing changing recipes can be optimized with regard to the adjusting parameters or the variation of the production parameters and can be improved further and further.

Also, an object of the present invention is a method for an optimized changing of a flat film machine from a feed product to a follow-on product. Such a method comprises the following steps:
acquiring at least one production parameter of the flat film machine,
optimizing at least one adjusting action of an adjusting module for the at least one acquired production parameter,
performing at least one adjusting action.

A method according to the invention is carried out in particular on a changing device according to the invention and in this way has the same advantages as have been explained in detail with reference to a changing device according to the invention. In particular, an optimized adjusting action can be used online or even beforehand during commissioning or as a factory setting.

A method according to the invention can be further formed in that at least one of the following production parameters is acquired:
width of a film track
number of layers of the film track
material composition of the film track
quality parameter of the film track
production stability of the film track
thickness of the film track
film thickness ratio of the film track
temperature profile of the film track in transverse direction and/or in production direction
width difference of the film track
adjusting profile of adjusting bolts of the outlet nozzle
machine parameter of the flat film machine
discharge width of the outlet nozzle
thickness profile of the film track.

The above list is not exhaustive. Of course, individual production parameters can also be combined with each other, so that a combined approach can form the basis for the method according to the invention.

It is also advantageous if, in a method according to the invention, the optimized adjusting action changes an outlet thickness of an outlet nozzle of the flat film machine locally and/or globally. In particular, a local adjustment of the outlet thickness, for example by changing local adjusting bolts, is carried out individually or in groups. However, a complete adjustment of the adjusting bolts, i.e. a global change of the outlet thickness in the sense of the present invention, is also conceivable in principle.

Further advantages are achieved if, in a method according to the invention, the optimized adjusting action changes an outlet width of an outlet nozzle of the flat film machine. The outlet width is achieved, for example, by changing the net width, but in particular by changing the gross width. Thus, automatically or semi-automatically, the described lateral deckling blades can move in or out, so that correspondingly wider or narrower melt can discharge from the outlet nozzle for producing the film track.

It can also be advantageous if, in a method according to the invention, the changing time is optimized so that it does not fall below a minimum production stability and/or does not exceed a maximum changing time. This prevents that falling below a minimum production stability could lead to impairment of the production speed and/or to film breakage. A maximum changing time prevents a machine specification, which specifies the maximum time for changing to the follow-on product, from being exceeded. These two limits can of course be predefined or adjustable.

It can also be advantageous if, in a method according to the invention, the optimization is performed on the basis of and/or taking into account stored, successful changings. For example, in the case of the same feed product and/or the same follow-on product, a stored successful changing recipe can be used in order to carry out exactly the same adjusting interventions by the adjusting module in accordance with this recipe. Even in the case of similar product ratios, stored effects of the individual materials can form the basis for an optimized changing. In particular, therefore, a direct copy of a corresponding changing recipe and direct use in the sense of the present invention are possible. In particular, this is combined with a learning system, as has already been explained.

Further advantages, features and details of the invention will be apparent from the following description, in which embodiments of the invention are described in detail with reference to the figures. Thereby, the features mentioned in the claims and in the description may each be essential to the invention individually or in any combination. The figures schematically show:

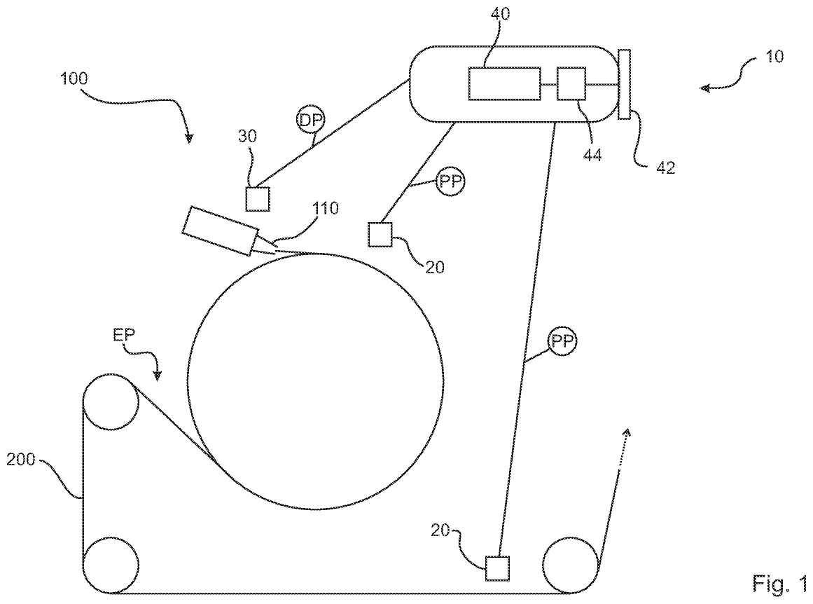

FIG. 1 an embodiment of a changing device according to the invention,

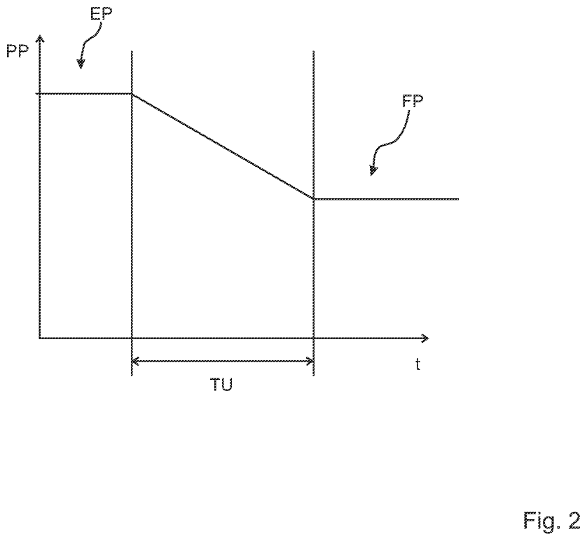

FIG. 2 the course of a production parameter and

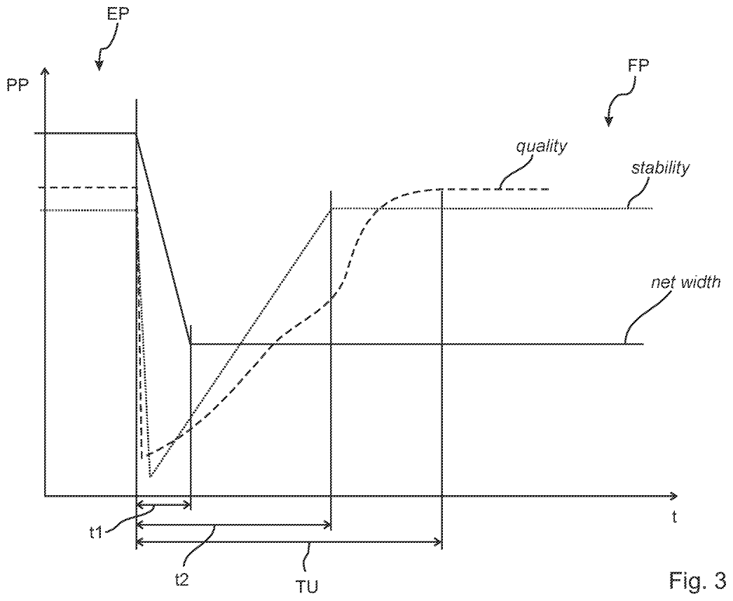

FIG. 3 the course of several production parameters.

FIG. 1 shows schematically how a flat film machine 100 can be equipped. The film melt is discharged via an outlet nozzle 110 and drawn off from the large roll shown in the center. On this large roll, the film track chills and cools down so that subsequently the film track can be further wound up in the form of the feed product EP conveyed over a plurality of rolls.

If a changing is now desired in a flat film machine 100 according to the embodiment in FIG. 1, a production parameter PP is recorded in a first step with the changing device 10 at a plurality of sensor modules, here at two locations. In the middle, for example, the frost line, as well as the film thickness can be acquired as production parameter PP. At the bottom right, a film parameter, such as the gross width or the film thickness, can also be forwarded to the controlling module 40 as production parameter PP. With the aid of a storage device 44 and/or an input device 42, it is now possible to make controlled specifications as to the direction in which the follow-on product is desired. In order to achieve the changing, a nozzle parameter DP is adjusted here by the adjusting module 30 directly at the outlet nozzle 110, so that it can subsequently be tracked at the corresponding sensor modules 20 how the film track changes. As soon as the desired final parameter of the follow-on product FP is reached, the feedback of the resumed good production can take place.

FIG. 2 shows how the changing takes place over time. The production parameter PP can, for example, refer to the desired net width of the film product, so that, according to FIG. 2, a narrower follow-on product FP is now to be produced from the feed product EP. During the changing, for example by the method of lateral deckling blades, the width from the feed product to the follow-on product FP is continuously reduced, in this case by continuously reducing the outlet width of the deckling blades. The time required from the good production of the top left feed product EP to the good production of the bottom right follow-on product is also referred to as the changing time TU.

FIG. 3 shows a somewhat more complex representation of a production parameter PP over time. Here, the net width, the stability and the quality of the film product are shown. While the net width essentially changes abruptly from the feed product EP shown in FIG. 2 to the follow-on product FP, the quality and stability develop in a different way. Thus, the quality of the follow-on product FP will drop in a first time window during the changing, only to rise again in time t2. At this point, after the significantly shorter time t1, the net width of the follow-on product FP has already been reached again. However, only when the quality has also reached the desired continuous limit, which is necessary for the follow-on product FP, the good production of the follow-on product is carried out when the changing time TU is reached.

The foregoing explanation of the embodiments describes the present invention exclusively in the context of examples. Of course, individual features of the embodiments can be freely combined with each other, provided that this is technically reasonable, without leaving the scope of the present invention.

### LIST OF REFERENCE SIGNS

10 changing device
20 sensor module
30 adjusting module
40 controlling module
42 input device
44 storage device
100 flat film machine
110 outlet nozzle
200 film track
EP feed product
FP follow-on product
TU changing time
PP production parameter
DP nozzle parameter

1. A changing device for a changing of a flat film machine from a feed product to a follow-on product, comprising a sensor module for acquiring at least one production parameter of the flat film machine and an adjusting module for a controlled change of this acquired at least one production parameter, further comprising a controlling module for controlling the adjusting module for an optimized changing time for the acquired at least one production parameter from the feed product to the follow-on product.

2. The changing device according to claim 1, wherein at least one of the following is acquired as a production parameter by the sensor module:
width of a film track
number of layers of the film track
material composition of the film track
quality parameter of the film track
production stability of the film track
thickness of the film track
film thickness ratio of the film track
temperature profile of the film track at least in transverse direction and/or in production direction
width difference of the film track
adjusting profile of adjusting bolts of the outlet nozzle
machine parameter of the flat film machine
discharge width of the outlet nozzle
thickness profile of the film track.

3. The changing device according to any one of the claim 1, wherein the adjusting module is configured for controlling at least one nozzle parameter of an outlet nozzle of the flat film machine.

4. The changing device according to claim 1, wherein, as at least one nozzle parameter, a nozzle discharge slot of the outlet nozzle and thus the local thickness of the discharged film track can be changed locally in a controlled manner.

5. The changing device according to claim 3, wherein the adjusting module is designed for a controlled variation of an outlet width of the outlet nozzle.

6. The changing device according to claim 1, wherein the adjusting module is designed for a controlled variation of a stretching parameter of the flat film machine.

7. The changing device according to claim 1, wherein the controlling module comprises an input device for inputting at least the follow-on product and/or a changing time.

8. The changing device according to claim 7, wherein the controlling module is configured for an input of an optimization focus.

9. The changing device according to claim 1, wherein an output device for an output of a predicted changing time is provided.

10. The changing device according to claim 1, wherein the controlling module comprises a storage device for a specific storage of effected changings from feed products to follow-on products.

11. The changing device according to claim 10, wherein the storage device comprises an evaluation module for an at least quantitative and/or qualitative evaluation of the stored changings.

12. A method for an optimized changing of a flat film machine from a feed product to a follow-on product, comprising the following steps:
acquiring at least one production parameter of the flat film machine,
optimizing at least one adjusting action of an adjusting module for the at least one acquired production parameter,
performing at least one adjusting action.

13. The method according to claim 12, wherein at least one of the following production parameters is acquired:
width of a film track
number of layers of the film track
material composition of the film track
quality parameter of the film track
production stability of the film track
thickness of the film track
film thickness ratio of the film track
temperature profile of the film track
width difference of the film track
adjusting profile of adjusting bolts of the outlet nozzle
machine parameter of the flat film machine
discharge width of the outlet nozzle
thickness profile of the film track.

14. The method according to claim 12, wherein the optimized adjusting action changes an outlet thickness of an outlet nozzle of the flat film machine at least locally and/or globally.

15. The method according to claim 12, wherein the optimized adjusting action changes an outlet width of an outlet nozzle of the flat film machine.

16. The method according to claim 12, wherein the changing time is optimized so that at least it does not fall below a minimum production stability or does not exceed a maximum changing time.

17. The method according to claim 12, wherein the optimization is performed at least on the basis of or taking into account stored, successful changings.

18. The changing device according to claim 7, wherein the controlling module is configured for an input of an optimization focus of the following:
threshold value for minimum production stability
threshold value for maximum changing time
threshold value for a maximum energy requirement
threshold value for minimum product quality.
